(19) United States
(12) Patent Application Publication
(10) Pub. No.: US 2014/0086310 A1
(43) Pub. Date: Mar. 27, 2014

(54) POWER EFFICIENT ENCODER ARCHITECTURE DURING STATIC FRAME OR SUB-FRAME DETECTION

(71) Applicants: Jason D. Tanner, Folsum, CA (US); Scott W. Cheng, Folsum, CA (US); George R. Hayek, El Dorado Hills, CA (US)

(72) Inventors: Jason D. Tanner, Folsum, CA (US); Scott W. Cheng, Folsum, CA (US); George R. Hayek, El Dorado Hills, CA (US)

(21) Appl. No.: 13/624,195

(22) Filed: Sep. 21, 2012

(51) Int. Cl. H04N 7/32

(52) U.S. Cl. 375/240.03; 375/E07.139; 375/E07.123

(57) ABSTRACT

Described herein are techniques related to power efficient encoder architecture during static frame or sub-frame detection. In particular, a method of implementing a power savings algorithm is described upon detection of the static frame or sub-frame by the encoder architecture.

### BACKGROUND

Video coding is a process of preparing video (video data), where the video is encoded to meet proper formats and specifications for recording and playback. Motion estimation is an important and computationally intensive task in video coding and video compression.

The Video Coding Experts Group (VCEG), together with the International Organization for Standardization (ISO)/International Electrotechnical Commission (IEC) joint working group, the Moving Picture Experts Group (MPEG), has developed the Advanced Video Coding (AVC) standard. The AVC standard, or AVC, is also known as H.264. The AVC is an example of a standard for video encoding, and is one of the most commonly used formats for the recording, compression, and distribution of high definition video. Other standards include and are not limited to, Motion Pictures Experts Group 2 (MPEG2), Scalable Video Coding (SVC), and High Efficiency Video Coding (HEVC), etc.

In a typical video encoding process, large power consumption in a video encoder circuitry may be related to a number of active processing circuitry required for implementing amount of computations in the video encoding process. To this end, the video encoder circuitry may be designed carefully to avoid consumption of large amount of power to maintain reliability in the video encoding process.

### BRIEF DESCRIPTION OF THE DRAWINGS

FIG. 1 illustrates an example system for implementing video encoding.

FIG. 2 illustrates an example encoder architecture to implement a power savings algorithm.

FIG. 3 illustrates an example encoder architecture configuration during detection of a static image frame.

FIG. 4 illustrates an example encoder architecture configuration upon obtaining a desired quantitative parameter (QP) value.

FIG. 5A illustrates an example video encoder processing of a detected static image frame.

FIG. 5B illustrates an example video encoder processing of a detected static image frame upon obtaining a desired quantitative parameter (QP) value for the detected static image frame.

FIG. 6 is an example method for implementing a power savings algorithm in a video encoder device.

FIG. 7 is an illustrative diagram of an example system that implements power efficiency during static frame or sub-frame detection.

FIG. 8 is an illustrative diagram of an example device, all arranged in accordance with at least some implementations of present disclosure.

The following Detailed Description is provided with reference to the accompanying figures. In the figures, the left-most digit(s) of a reference number usually identifies the figure in which the reference number first appears. The use of the same reference numbers in different figures indicates similar or identical items.

### DETAILED DESCRIPTION

This document discloses one or more systems, apparatuses, methods, etc. for implementing a power efficient encoder architecture during static frame or sub-frame detection. In an implementation, the encoder architecture may detect the static frame (or sub-frame) through a display capture component that may include a buffer memory for data (e.g., images) to be displayed in a wireless display (WiDi) device. In this implementation, the encoder architecture may utilize this detection to disable internal components to minimize power consumption. For example, the internal components may include hierarchical motion estimation (HME) component, integer motion estimation (IME) component, zero motion vector (ZMV) component and intra (I) frame encoding component. In an implementation, the encoder architecture may disable the HME, IME, and I frame encoding components during the detection of the static frame. The presence of the static frame may generate zero motion vectors and as such, the enabling of the ZMV component may be sufficient to provide a quality encoding for the static frame. Furthermore, the quality encoding for the static frame may be improved by continuously reducing quantization parameter (QP) value for the static frame until a desired quality (i.e., QP value) is reached. In an implementation, the ZMV component may be further disabled (i.e., during a SKIP mode) once the QP is at desired value to provide additional power savings to the encoder architecture. The SKIP mode may be implemented until the static frame or sub frame is turned off Turning off may include detection of another image frame for encoding, which may e by a video component or display capture component. Accordingly, the desired quality for the static frame or sub frame may be obtained in addition to power savings generated by the disabling of the encoder internal components.

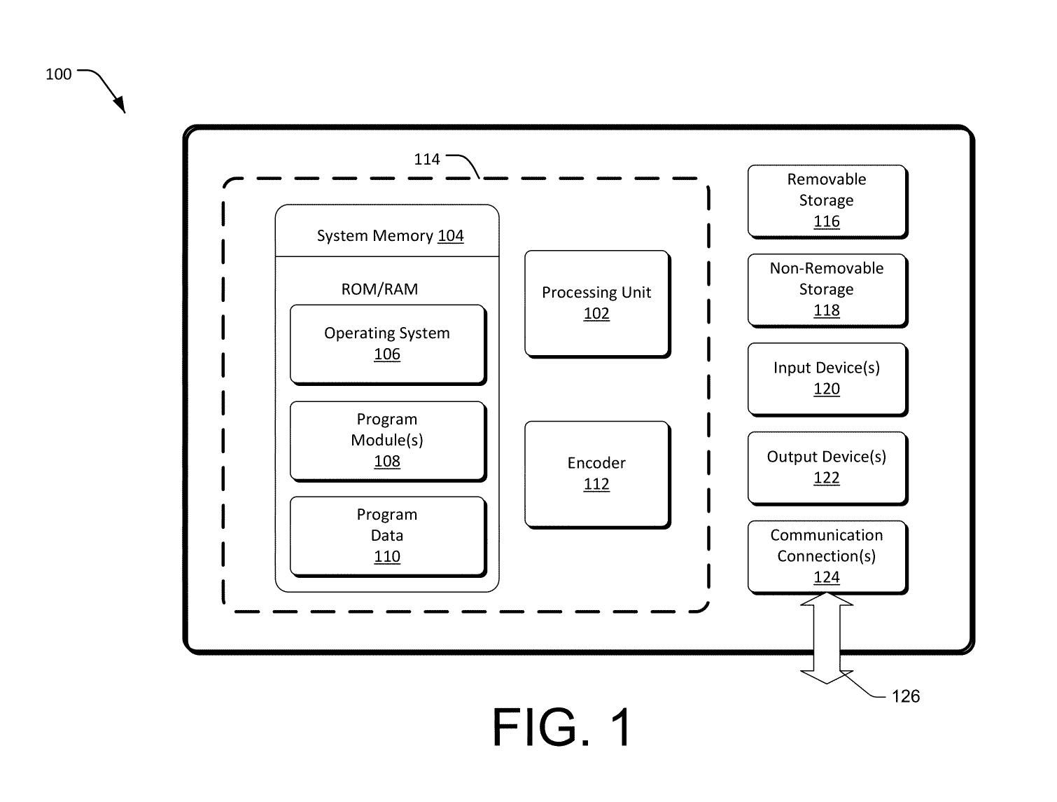

FIG. 1 shows an example system that may be utilized to implement various described embodiments. However, it will be readily appreciated that the techniques disclosed herein may be implemented in other computing devices, systems, and environments. The computing device 100 shown in FIG. 1 is one example of a computing device and is not intended to suggest any limitation as to the scope of use or functionality of the computer and network architectures.

In at least one implementation, computing device 100 includes at least one processing unit 102 and system memory 104. Depending on the exact configuration and type of computing device, system memory 104 may be volatile (such as RAM), non-volatile (such as ROM, flash memory, etc.) or some combination thereof. System memory 104 may include an operating system 106, one or more program modules 108, that in certain implementations may implement the power saving algorithm methods and techniques describe herein. System memory 104 may further include program data 110 which may include macro block (MB) or shapes database(s) as described later in this document. Furthermore, an encoder 112 is included in this example. The encoder 112 may be used to implement video encoding, motion estimation, motion compensation, etc. as describe herein. The encoder 112 may be operatively coupled to and communicate with processing unit 102, system memory 104, and other memory, input/output, devices, further described herein, and other components/devices not shown. A basic implementation of the computing device 100 is demarcated by a dashed line 114. For example, in certain implementations, encoder 112 may be part of an integrated graphics chip set in of central processing units (CPU) that includes 3D and media, having media functionality that includes video, specifically video decode/encode. In certain implementations, an application specific integrated circuit or ASIC may include the encoder 112 as a fixed function encoder.

It is contemplated that devices with video encoding may make use of the techniques, methods, and devices described. Examples of such devices include media players, video conferencing devices, etc.

In certain implementations, program modules 108 may include specific modules (not shown) such as a codec or software/firmware based encoder, configured to implement the video encoding techniques and methods described herein. For example, such modules in certain implementations may perform the processes of encoder 112. Example codecs include AVC, VC1, ATVC, and SVC.

Computing device 100 may have additional features or functionality. For example, computing device 100 may also include additional data storage devices such as removable storage 116 and non-removable storage 118. In certain implementations, the removable storage 116 and non-removable storage 118 are an example of computer accessible media for storing instructions that are executable by the processing unit 102 to perform the various functions described above. Generally, any of the functions described with reference to the figures may be implemented using software, hardware (e.g., fixed logic circuitry) or a combination of these implementations. Program code may be stored in one or more computer accessible media or other computer-readable storage devices. Thus, the processes and components described herein may be implemented by a computer program product. As mentioned above, computer accessible media includes volatile and non-volatile, removable and non-removable media implemented in any method or technology for storage of information, such as computer readable instructions, data structures, program modules, or other data. The terms “computer accessible medium” and “computer accessible media” refer to non-transitory storage devices and include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transitory medium that may be used to store information for access by a computing device, e.g., computing device 100. Any of such computer accessible media may be part of the computing device 100.

In one implementation, the removable storage 116, which is a computer accessible medium, has a set of instructions stored thereon. When executed by the processing unit 102, the set of instructions cause the processing unit 102 to execute operations, tasks, functions and/or methods as described herein, and any variations thereof.

Computing device 100 may also include one or more input devices 120 such as keyboard, mouse, pen, voice input device, touch input device, etc. Computing device 100 may additionally include one or more output devices 122 such as a display, speakers, printer, etc.

Computing device 100 may also include one or more communication connections 124 that allow the computing device 100 to communicate by wire or wirelessly with one or more other devices (not shown), over connection 126. It is appreciated that the illustrated computing device 100 is one example of a suitable device and is not intended to suggest any limitation as to the scope of use or functionality of the various embodiments described.

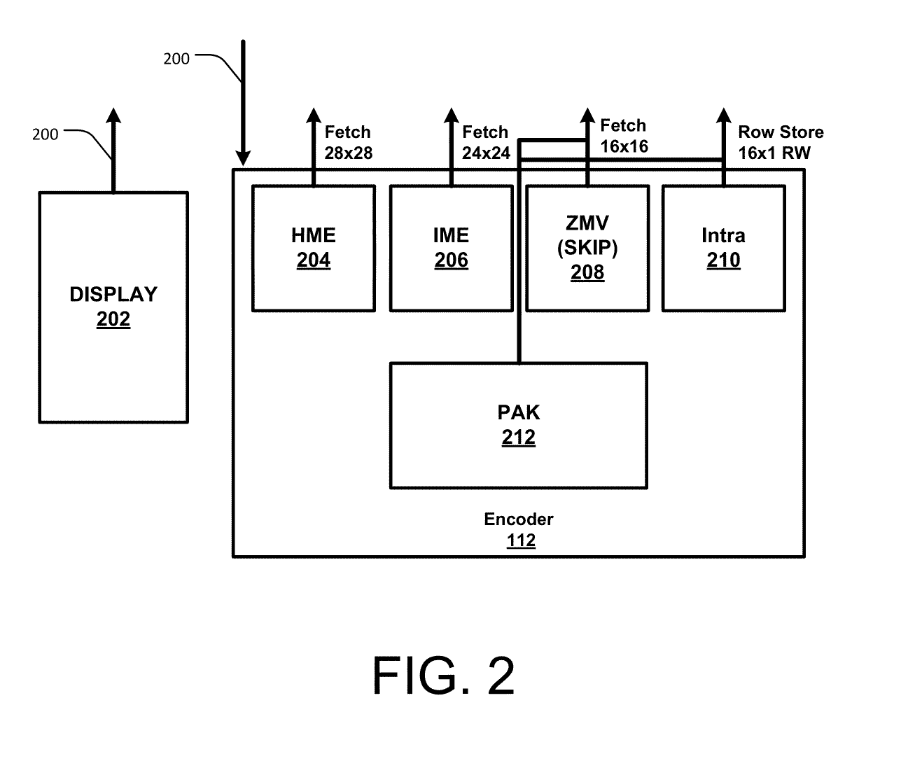

FIG. 2 shows an example video encoder 112 that implements the power saving algorithm when the static frame (or static sub-frame) is detected. In an implementation, the power saving algorithm during the detection of the static frame may be implemented at the same time that the QP for the static frame is dynamically decreased or replenished for improved quality. In this implementation, the QP may regulate how much spatial detail is saved for the static frame. For example, when the QP is relatively small, almost all of the spatial detail is retained and the quality is emphasized. As the QP increases, some of the spatial detail is aggregated so that bit rate drops—at a price of increasing distortion and loss of quality for the detected static frame. In other words, for a particular detected static image frame (not shown) to be processed, decreasing the QP to a configured value while implementing the power saving algorithm (e.g., disabling video encoder 112 components) may provide an efficient encoding approach for the particular static image frame.

In certain implementations, the video encoder 112 may be implemented as part of a central processing unit, part of integrated circuit chipset, or be a separate component/device. As discussed above, in certain implementations, the video encoder 112 may be implemented as firmware or software, such as a codec. Furthermore, FIG. 2 is merely illustrative and may contain additional blocks or components and/or different arrangement of the blocks or components.

In an implementation, the video encoder 112 may receive an image frame (data) 200 from a display capture 202, and processes the image frame 200 through mode decision components such as a HME component 204, IME component 206, a ZMV component 208, and I frame encoding approach component 2010. In this implementation, the mode decision components may transmit encoded bit-streams through a bit-packing (PAK) hardware component 210.

In an implementation, the display capture 202 may provide or capture the image frame 200 (e.g., static image frame 200) that are to be encoded by the video encoder 112 to generate corresponding encoded frames in the form of encoded bit-streams, which include series or combinations of I, predictive (P), and/or bidirectional (B) streams from the PAK component 212. In an implementation, one or more blocks of the video encoder 112 may be configured to perform video encoding consistent with one or more standards such as, MPEG, H.264, etc. For example, the image frame 200 from the display capture 202 may be processed by the HME component 204, which is a widely applied approach to motion estimation. In an implementation, two frames (e.g., frame k and frame k+1) may undergo a process of size and resolution reduction (i.e., different levels of different resolutions are created). In this implementation, the HME component 204 may perform an algorithm to create different levels for the two frames to estimate the motion vector. The motion vector may be used by the HME component 204 to encode the received image frame 200.

In an implementation, the IME component 206 may implement another decision mode for the encoder 112 in encoding the image frame 200 into encoded bit streams (not shown) through the PAK component 212. The IME component 206 may provide a relatively high power consuming component for the video encoder 112 due to huge computational complexity and memory bandwidth requirements during encoding processing of the image frame 200. For example, the IME component 206 supports multiple reference frames and inter modes of different block sizes and shapes. In this example, the IME component 206—when encoding the image frame 200—may compare all values of different block sizes for the MB of the image frame 200 to find the best inter mode with the least rate distortion cost. To this end, the IME component 206 may incur the relatively high computation cost and accordingly generates high power consumption.

In an implementation, the ZMV component 208 may implement another decision mode for the encoder 112 to encode the image frames 200 into encoded bit streams. In an implementation, the ZMV component 208 may process the received image frame 200 when the motion vector is presumed to be zero (i.e., static image frame 200). In this implementation, the encoder 112 may detect and receive the static image frame 200 through the display component 202 and processes the static image frame 200 at the ZMV component 208. In an implementation, the ZMV component 208—at SKIP mode —may include a SKIP MB (not shown) that is the MB (e.g., 16 by 16 displayed pixels) for which no information is sent to a decoder (not shown) by the encoder 112. For example, the ZMV component 208 may transmit no coded coefficients for the static image frame 200 and no prediction information during the encoding process. In this example, the encoder 112 may choose the SKIP mode for the MB in a P- or B-slice. Furthermore, the decoder (not shown) may estimate the motion vector for the skipped MB from neighboring coded MBs and uses this estimation to calculate a motion compensated prediction for the skipped MB. In this implementation, the encoder 112 may choose whether to code (i.e., with coefficients) the MB (not shown) of the static image frame 200 through the ZMV component 208, or skip (i.e., no coefficients) the MB (not shown) at the SKIP mode. Typically, the encoder 112 may skip the coding of the MB (not shown) when a rate-distortion cost of the SKIP mode is lower than any coded mode.

In an implementation, the I encoding approach component 210 may implement another decision mode for the encoder 112 to encode the image frames 200 into encoded bit streams. In this implementation, the I encoding approach component 210 may include an encoding approach where the MBs (not shown) of the image frame 200 are represented based on the MBs (not shown) of the same frame (i.e., the image frame 200 is coded without reference to any other image frame 200 except itself). In an implementation, during the detection of the static image frame 200, the encoder 112 may be configured to disable the I encoding approach component 210 together with the other decision modes such as the HME component 204 and the IME component 206. For example, the presence of the static image frame 200 may generate zero motion vectors and as such, the HME component 204, IME component 206 and I encoding approach component 210 may be disabled without affecting the encoding of the static image frame 200 into encoded bit streams. In this example, the ZMV component 208 may be enabled to encode the static image frame 200. The encoding by the ZMV component 208 may be implemented through the SKIP mode or non-SKIP mode. In other words, the MBs (not shown) of the static image frame 200 may be skipped or coded during SKIP mode or non-SKIP mode encoding, respectively.

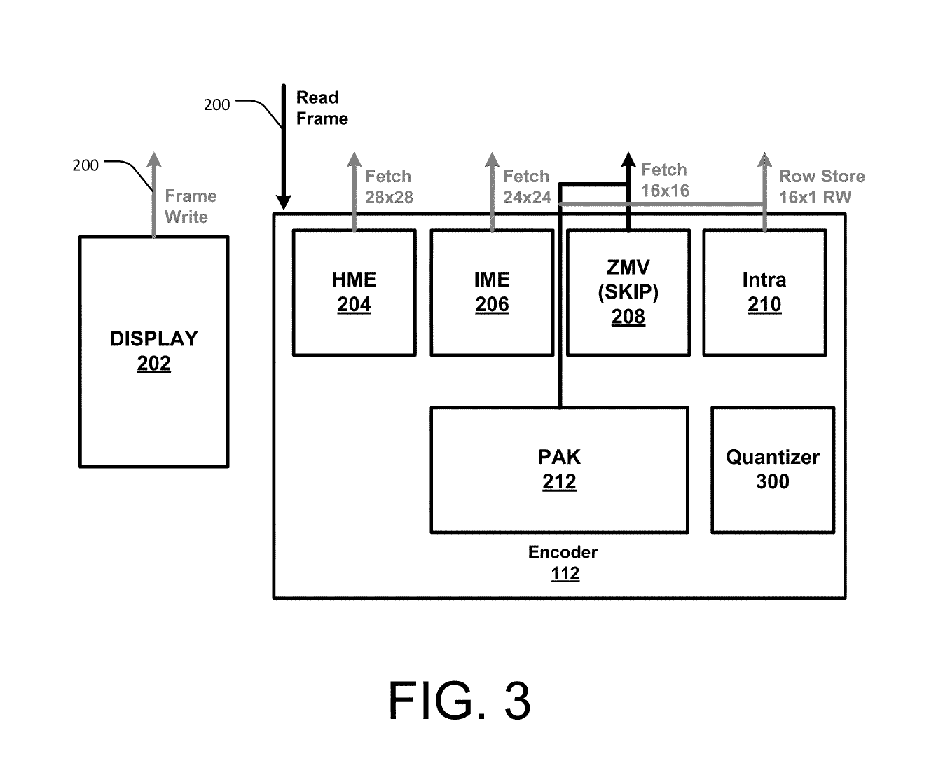

FIG. 3 illustrates the encoder 112 configuration during the detection of the static image frame 200. In an implementation, the encoder 112 may be configured to disable the HME component 204, IME component 206 and I encoding approach component 210 during the detection of the static image frame 200. In this implementation, the ZMV component 208 is enabled while the QP may be replenished through a quantizer component 300 in order to provide a good quality encoding for the static image frame 200. For example, during the static image frame 200 encoding by the ZMV component 208, the quality encoding for the static image frame 200 may be improved or replenished by continuously reducing value of the QP (not shown) in the quantizer component 300 until a desired quality is reached. Once the desired QP (not shown) value is obtained, the ZMV component 208 may be further disabled if the encoder 112 chooses the SKIP mode for encoding the MBs (not shown) of the static image frame 200. The SKIP mode may be implemented until the static image frame 200 is turned off. On the other hand, the ZMV component 208 may not be disabled if the non-SKIP mode is chosen to encode the static image frame 200. The non-SKIP mode may be chosen if distortions (not shown) are negligible as against SKIP mode operation for the ZMV component 208. Either way, the desired quality for the static image frame 200 may be obtained and additional power savings may also be generated by the disabling of the encoder 112 mode decision components as described above. In other implementations, the desired quality and additional power savings may be obtained for a particular static region (not shown) of the static image frame 200 by applying the operations as described above.

In an implementation, the quantizer component 300 may be controlled by any one of the mode decision components (e.g., enabled HME component 204) for encoding the image frame 200 in a single passing. The quantizer component 300 may include a dynamically adjustable QP that is used as a key parameter for controlling amount of information to be kept or thrown out during the encoding approach. For example, the higher the QP, the lesser the information is retained, and as such, the quality of the encoding approach is decreased. Similarly, the lower the QP, the higher the information that is kept, and as such, the quality of the encoding approach is increased. In an implementation, a look-up table (not shown) may be used for proper configuration of the dynamically adjustable QP in the quantizer component 300. In this implementation, the QP of the quantizer component 300 is reset to its initial value when another static frame or sub-frame 200 is detected by the display component 202.

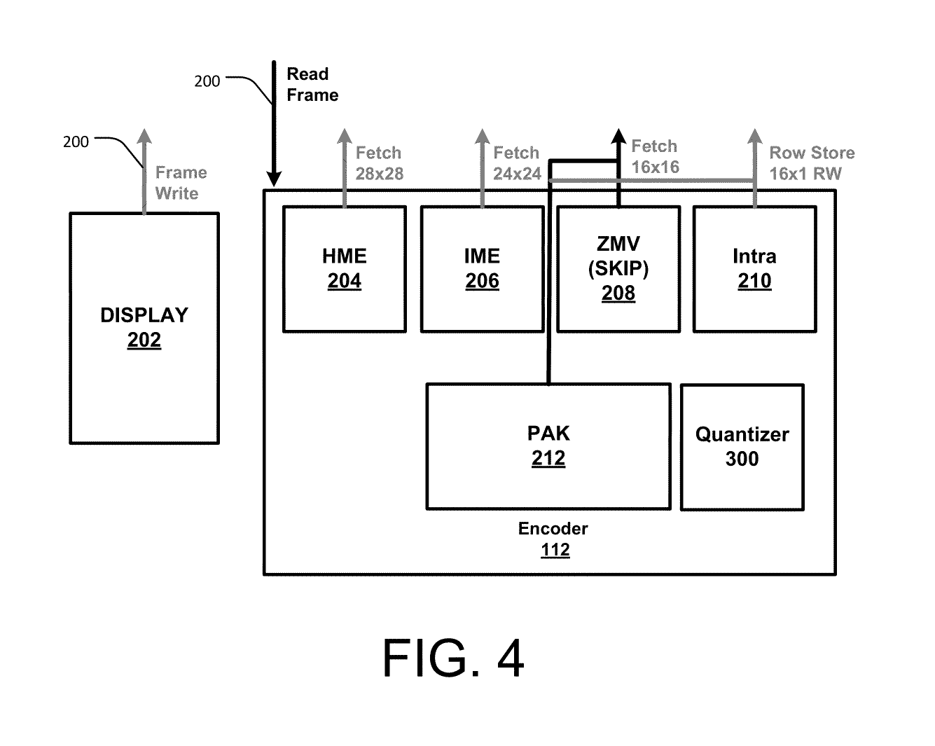

FIG. 4 illustrates the encoder 112 configuration after the desired QP value is obtained during the encoding of the static image frame 200. In an implementation, the encoder 112 may be configured to disable all of the mode decision components such as the HME component 204, IME component 206, ZMV component 208, and I encoding approach component 210. In this implementation, the ZMV component 208 is at SKIP mode and the MBs (not shown) for the static image frame 200 may be decoded based on neighboring coded MBs (not shown). Furthermore, the PAK component 212 and the Quantizer component 300 may be disabled when the desired QP (not shown) is attained. In an implementation, the QP value (not shown) for the static image frame 200 may be decreased to a certain configured value (not shown) while the ZMV component 208 and the PAK component 212 are enabled as discussed in FIG. 3. In this implementation, the ZMV component 208 at SKIP mode may thereafter be disabled to obtain the power savings in the encoder 112 while obtaining the good quality during the encoding approach. The mode decision components may be activated at another instance where another static image frame 200 is detected.

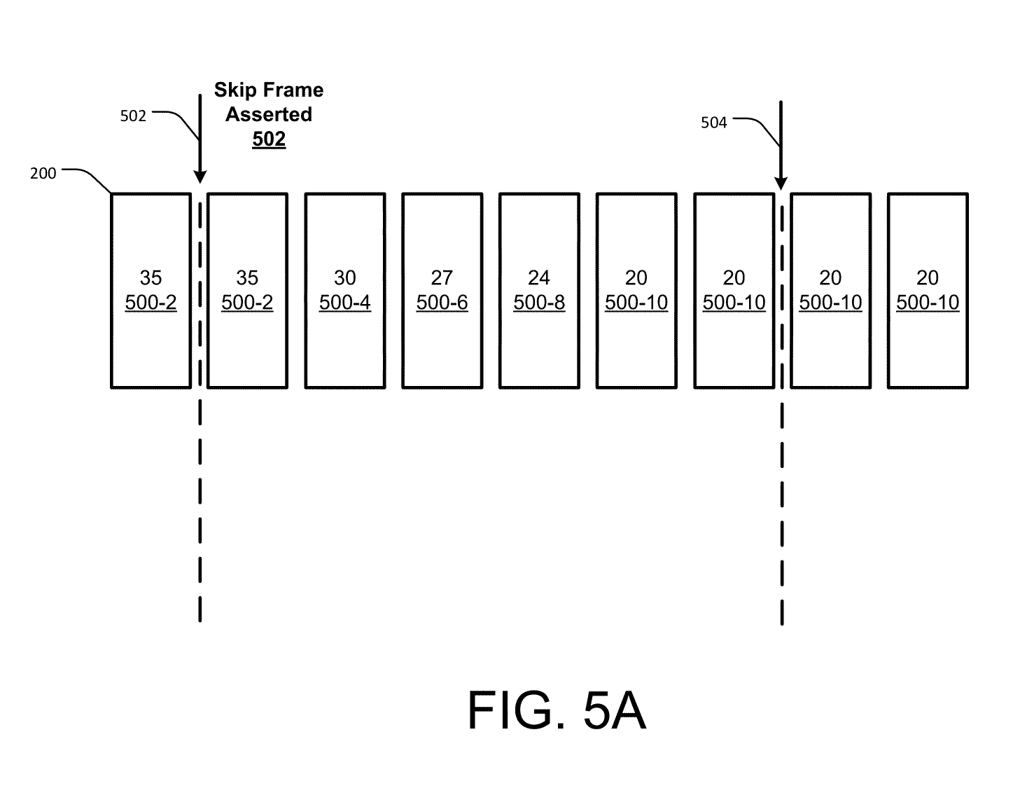

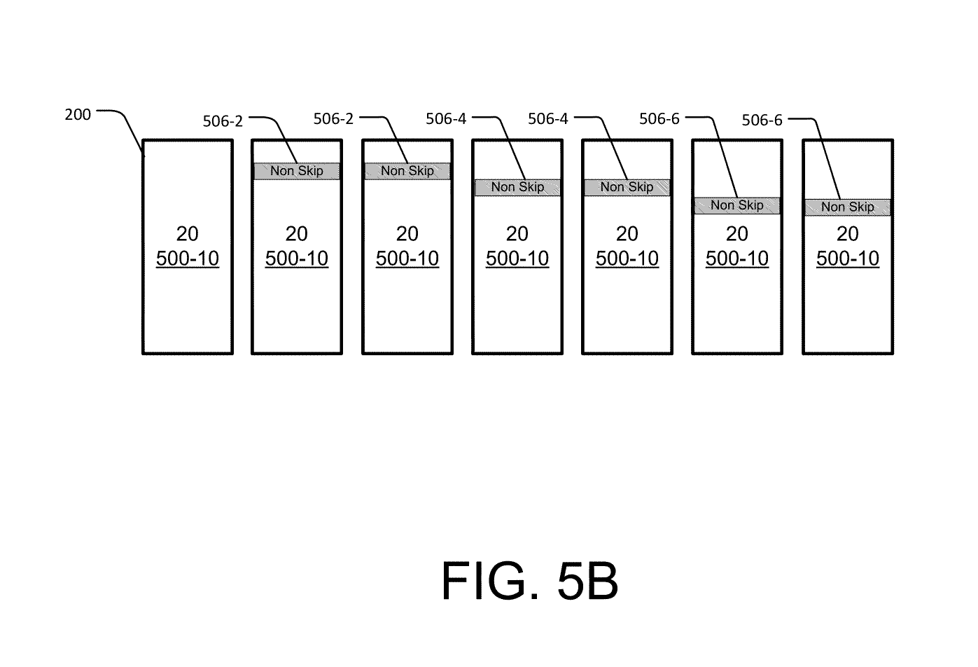

FIG. 5A shows an example video encoder 112 processing of the detected static image frame 200 during the power saving algorithm implementation. In an implementation, a QP 500 for the detected static image frame 200 may be dynamically decreased in value to obtain a desired QP value such as, a value of 20 as shown in QP 500-10. For example, the detected static image frame 200 may include an initial QP value of 35 as shown in QP 500-2. In this example, the video encoder 112 may be configured to assert skip frame 502 to begin processing of the detected image frame 200 that includes the initial QP value of 35. During the assertion of the skip frame 502, the video encoder 112 may be configured to disable other decision mode components such as the HME component 204, IME component 206, and I encoding approach component 210. In other words, the ZMV component 208, PAK component 212, and quantizer component 300 may be enabled to implement the decreasing of the QP value from the initial value of 35 to 30, 30 to 27, 27 to 24, and 24 to final value of 20 as shown in QP 500-4, 500-6, 500-8, and 500-10, respectively.

In an implementation, the ZMV component 208, PAK component 212, and quantizer component 300 may also be disabled at point 504 after the desired QP value (i.e., 20 at QP 500-10) is obtained. In this implementation, the ZMV component 208 is at SKIP mode and the disabling of the decision mode components may continue until the static image frame 200 is turned off (i.e., another image frame 200 is detected for encoding by the video encoder 112).

FIG. 5B shows an example video encoder 112 processing of the detected static image frame 200 when the desired QP value is obtained. In an implementation, the desired QP value of 20 in QP 500-10 may be derived during the power saving algorithm implementation as discussed in FIG. 5A above. In this implementation, a device such as a movement of a mouse (not shown) may bring about a small change (e.g., slice level change) on the encoding of the static image frame 200. The small change (i.e., non-static sub-frame or slice) may be represented by a non-skip region 506 that may be encoded without changing the encoding approach for the rest of the static image frame 200. For example, the non-skip 506-2 may represent a sub-frame that is encoded by the ZMV component 208 while the rest of the static image frame 200 is transmitted at skip mode (i.e., no coefficients).

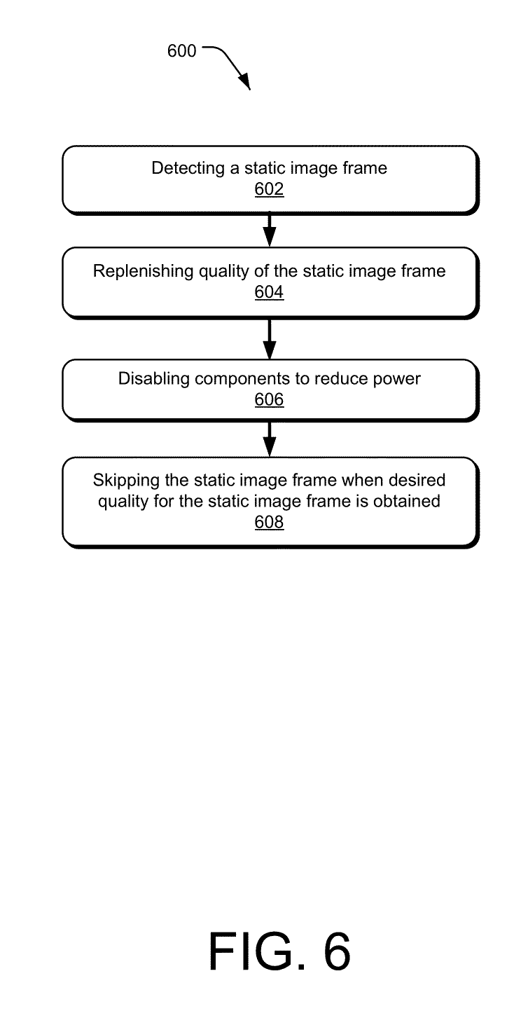

FIG. 6 shows an example process flowchart 600 illustrating an example method for implementing the power savings algorithm in a video encoder. The order in which the method is described is not intended to be construed as a limitation, and any number of the described method blocks can be combined in any order to implement the method, or alternate method. Additionally, individual blocks may be deleted from the method without departing from the spirit and scope of the subject matter described herein. Furthermore, the method may be implemented in any suitable hardware, software, firmware, or a combination thereof, without departing from the scope of the invention.

At block 602, detecting a static image frame is performed. In an implementation, a display component (e.g., display component 202) may detect the static image frame (e.g., static image frame 200) that is read by a video encoder (e.g., video encoder 112).

At block 604, replenishing quality of the static image frame 200 is performed. In an implementation, the detected static image frame 200 may include an initial QP value (e.g., QP 500-2) that is gradually decreased until a desired QP value (e.g., QP 500-10) is obtained. In this implementation, a quantizer component (e.g., quantizer component 300) is used to dynamically adjust the value of the QP 500 to obtain the desired value QP 500-10.

At block 606, disabling of video encoder components is performed. In an implementation, during the replenishment or recovery of the desired value QP 500-10, the video encoder 112 may disable some of the decision mode components such as HME component 204, IME component 206, and I encoding approach component 210. In this implementation, the ZMV component 208 may be enabled by the video encoder 112 until the QP 500-10 is obtained.

At block 608, skipping static image frame is performed. In an implementation, the video encoder 112—at SKIP mode—may disable the ZMV component 208 and PAK parameter component 212 after the QP 500-10 (i.e., desired QP value) is obtained. In this implementation, the disabled decision mode components may be maintained until the detected static image frame 200 is turned off. In another implementation such as when a device (e.g., mouse) provides a slice level change on the detected static image frame 200, the slice level change may be coded in non-skip mode and may be represented by non-skip region (e.g., non-skip 500) in the static image frame 200.

In the above description of example implementations, for purposes of explanation, specific numbers, materials configurations, and other details are set forth in order to better explain the present invention, as claimed. However, it will be apparent to one skilled in the art that the claimed invention may be practiced using different details than the example ones described herein. In other instances, well-known features are omitted or simplified to clarify the description of the example implementations.

The inventors intend the described example implementations to be primarily examples. The inventors do not intend these example implementations to limit the scope of the appended claims. Rather, the inventors have contemplated that the claimed invention might also be embodied and implemented in other ways, in conjunction with other present or future technologies.

As used in this application, the term “or” is intended to mean an inclusive “or” rather than an exclusive “or.” That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more,” unless specified otherwise or clear from context to be directed to a singular form.

These processes are illustrated as a collection of blocks in a logical flow graph, which represents a sequence of operations that may be implemented in mechanics alone or a combination with hardware, software, and/or firmware. In the context of software/firmware, the blocks represent instructions stored on one or more computer-readable storage media that, when executed by one or more processors, perform the recited operations.

Note that the order in which the processes are described is not intended to be construed as a limitation, and any number of the described process blocks may be combined in any order to implement the processes or an alternate process. Additionally, individual blocks may be deleted from the processes without departing from the spirit and scope of the subject matter described herein.

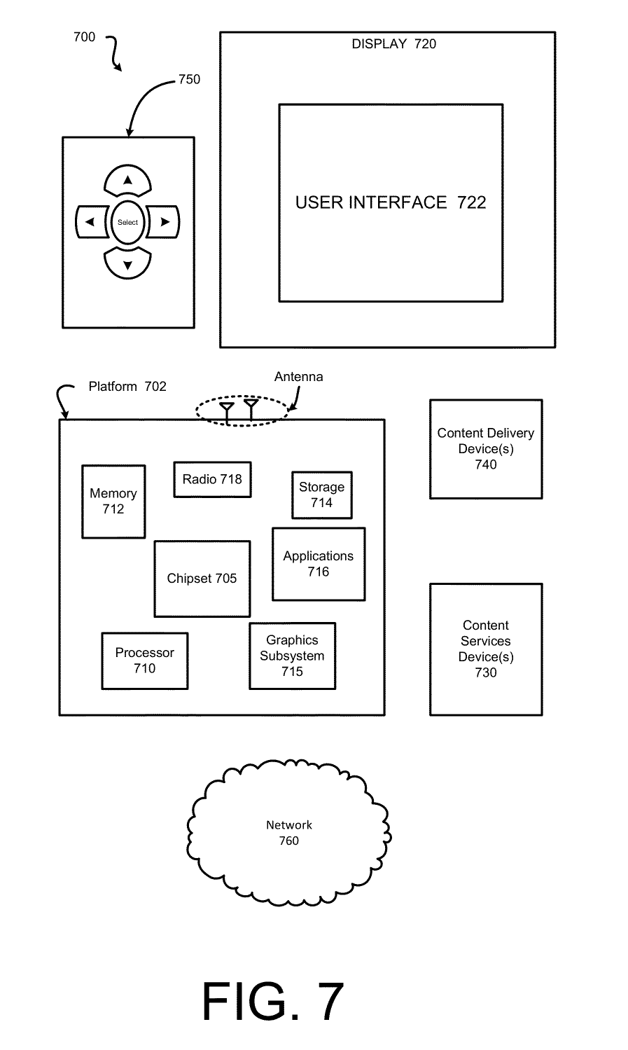

FIG. 7 illustrates another example system 700 in accordance with the present disclosure. In various implementations, system 700 may be a media system although system 700 is not limited to this context. For example, system 700 may be incorporated into a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

In various implementations, system 700 includes a platform 702 coupled to a display 720. Platform 702 may receive content from a content device such as content services device(s) 730 or content delivery device(s) 740 or other similar content sources. A navigation controller 750 including one or more navigation features may be used to interact with, for example, platform 702 and/or display 720. Each of these components is described in greater detail below.

In various implementations, platform 702 may include any combination of a chipset 705, processor 710, memory 712, storage 714, graphics subsystem 715, applications 716 and/or radio 718. Chipset 705 may provide intercommunication among processor 710, memory 712, storage 714, graphics subsystem 715, applications 716 and/or radio 718. For example, chipset 705 may include a storage adapter (not depicted) capable of providing intercommunication with storage 714.

Processor 710 may be implemented as a Complex Instruction Set Computer (CISC) or Reduced Instruction Set Computer (RISC) processors, x86 instruction set compatible processors, multi-core, or any other microprocessor or central processing unit (CPU). In various implementations, processor 710 may be dual-core processor(s), dual-core mobile processor(s), and so forth.

Memory 712 may be implemented as a volatile memory device such as, but not limited to, a Random Access Memory (RAM), Dynamic Random Access Memory (DRAM), or Static RAM (SRAM).

Storage 714 may be implemented as a non-volatile storage device such as, but not limited to, a magnetic disk drive, optical disk drive, tape drive, an internal storage device, an attached storage device, flash memory, battery backed-up SDRAM (synchronous DRAM), and/or a network accessible storage device. In various implementations, storage 714 may include technology to increase the storage performance enhanced protection for valuable digital media when multiple hard drives are included, for example.

Graphics subsystem 715 may perform processing of images such as still or video for display. Graphics subsystem 715 may be a graphics processing unit (GPU) or a visual processing unit (VPU), for example. An analog or digital interface may be used to communicatively couple graphics subsystem 715 and display 720. For example, the interface may be any of a High-Definition Multimedia Interface, DisplayPort, wireless HDMI, and/or wireless HD compliant techniques. Graphics subsystem 715 may be integrated into processor 710 or chipset 705. In some implementations, graphics subsystem 715 may be a stand-alone card communicatively coupled to chipset 705.

The graphics and/or video processing techniques described herein may be implemented in various hardware architectures. For example, graphics and/or video functionality may be integrated within a chipset. Alternatively, a discrete graphics and/or video processor may be used. As still another implementation, the graphics and/or video functions may be provided by a general purpose processor, including a multi-core processor. In further embodiments, the functions may be implemented in a consumer electronics device.

Radio 718 may include one or more radios capable of transmitting and receiving signals using various suitable wireless communications techniques. Such techniques may involve communications across one or more wireless networks. Example wireless networks include (but are not limited to) wireless local area networks (WLANs), wireless personal area networks (WPANs), wireless metropolitan area network (WMANs), cellular networks, and satellite networks. In communicating across such networks, radio 718 may operate in accordance with one or more applicable standards in any version.

In various implementations, display 720 may include any television type monitor or display. Display 720 may include, for example, a computer display screen, touch screen display, video monitor, television-like device, and/or a television. Display 720 may be digital and/or analog. In various implementations, display 720 may be a holographic display. Also, display 720 may be a transparent surface that may receive a visual projection. Such projections may convey various forms of information, images, and/or objects. For example, such projections may be a visual overlay for a mobile augmented reality (MAR) application. Under the control of one or more software applications 716, platform 702 may display user interface 722 on display 720.

In various implementations, content services device(s) 730 may be hosted by any national, international and/or independent service and thus accessible to platform 702 via the Internet, for example. Content services device(s) 730 may be coupled to platform 702 and/or to display 720. Platform 702 and/or content services device(s) 730 may be coupled to a network 760 to communicate (e.g., send and/or receive) media information to and from network 760. Content delivery device(s) 740 also may be coupled to platform 702 and/or to display 720.

In various implementations, content services device(s) 730 may include a cable television box, personal computer, network, telephone, Internet enabled devices or appliance capable of delivering digital information and/or content, and any other similar device capable of unidirectionally or bidirectionally communicating content between content providers and platform 702 and/display 720, via network 760 or directly. It will be appreciated that the content may be communicated unidirectionally and/or bidirectionally to and from any one of the components in system 700 and a content provider via network 760. Examples of content may include any media information including, for example, video, music, medical and gaming information, and so forth.

Content services device(s) 730 may receive content such as cable television programming including media information, digital information, and/or other content. Examples of content providers may include any cable or satellite television or radio or Internet content providers. The provided examples are not meant to limit implementations in accordance with the present disclosure in any way.

In various implementations, platform 702 may receive control signals from navigation controller 750 having one or more navigation features. The navigation features of controller 750 may be used to interact with user interface 722, for example. In embodiments, navigation controller 750 may be a pointing device that may be a computer hardware component (specifically, a human interface device) that allows a user to input spatial (e.g., continuous and multi-dimensional) data into a computer. Many systems such as graphical user interfaces (GUI), and televisions and monitors allow the user to control and provide data to the computer or television using physical gestures.

Movements of the navigation features of controller 750 may be replicated on a display (e.g., display 720) by movements of a pointer, cursor, focus ring, or other visual indicators displayed on the display. For example, under the control of software applications 716, the navigation features located on navigation controller 750 may be mapped to virtual navigation features displayed on user interface 722, for example. In embodiments, controller 750 may not be a separate component but may be integrated into platform 702 and/or display 720. The present disclosure, however, is not limited to the elements or in the context shown or described herein.

In various implementations, drivers (not shown) may include technology to enable users to instantly turn on and off platform 702 like a television with the touch of a button after initial boot-up, when enabled, for example. Program logic may allow platform 702 to stream content to media adaptors or other content services device(s) 730 or content delivery device(s) 740 even when the platform is turned “off” In addition, chipset 705 may include hardware and/or software support for 5.1 surround sound audio and/or high definition 7.1 surround sound audio, for example. Drivers may include a graphics driver for integrated graphics platforms. In embodiments, the graphics driver may comprise a peripheral component interconnect (PCI) Express graphics card.

In various implementations, any one or more of the components shown in system 700 may be integrated. For example, platform 702 and content services device(s) 730 may be integrated, or platform 702 and content delivery device(s) 740 may be integrated, or platform 702, content services device(s) 730, and content delivery device(s) 740 may be integrated, for example. In various embodiments, platform 702 and display 720 may be an integrated unit. Display 720 and content service device(s) 730 may be integrated, or display 720 and content delivery device(s) 740 may be integrated, for example. These examples are not meant to limit the present disclosure.

In various embodiments, system 700 may be implemented as a wireless system, a wired system, or a combination of both. When implemented as a wireless system, system 700 may include components and interfaces suitable for communicating over a wireless shared media, such as one or more antennas, transmitters, receivers, transceivers, amplifiers, filters, control logic, and so forth. An example of wireless shared media may include portions of a wireless spectrum, such as the RF spectrum and so forth. When implemented as a wired system, system 700 may include components and interfaces suitable for communicating over wired communications media, such as input/output (I/O) adapters, physical connectors to connect the I/O adapter with a corresponding wired communications medium, a network interface card (MC), disc controller, video controller, audio controller, and the like. Examples of wired communications media may include a wire, cable, metal leads, printed circuit board (PCB), backplane, switch fabric, semiconductor material, twisted-pair wire, co-axial cable, fiber optics, and so forth.

Platform 702 may establish one or more logical or physical channels to communicate information. The information may include media information and control information. Media information may refer to any data representing content meant for a user. Examples of content may include, for example, data from a voice conversation, videoconference, streaming video, electronic mail (“email”) message, voice mail message, alphanumeric symbols, graphics, image, video, text and so forth. Data from a voice conversation may be, for example, speech information, silence periods, background noise, comfort noise, tones and so forth. Control information may refer to any data representing commands, instructions or control words meant for an automated system. For example, control information may be used to route media information through a system, or instruct a node to process the media information in a predetermined manner. The embodiments, however, are not limited to the elements or in the context shown or described in FIG. 7.

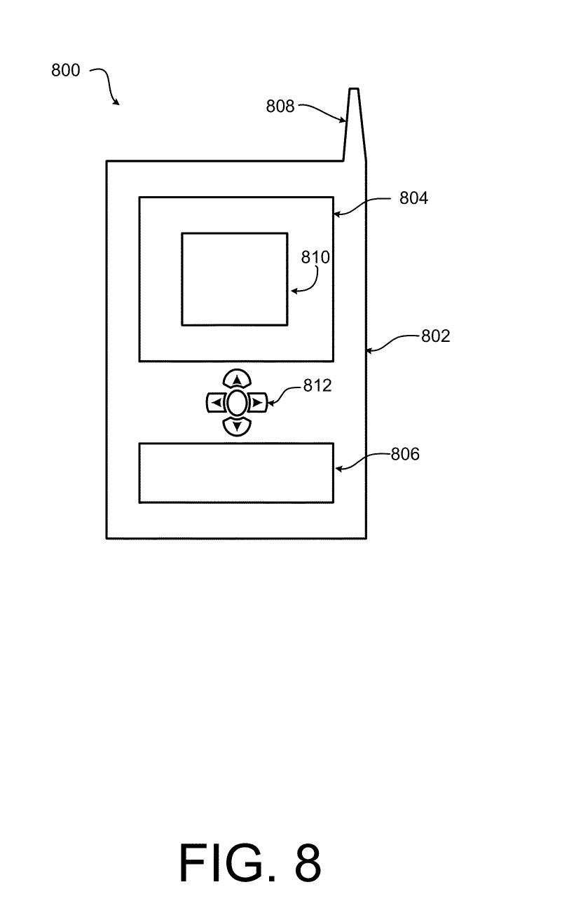

As described above, system 700 may be embodied in varying physical styles or form factors. FIG. 8 illustrates implementations of a small form factor device 800 in which system 700 may be embodied. In embodiments, for example, device 800 may be implemented as a mobile computing device having wireless capabilities. A mobile computing device may refer to any device having a processing system and a mobile power source or supply, such as one or more batteries, for example.

As described above, examples of a mobile computing device may include a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

Examples of a mobile computing device also may include computers that are arranged to be worn by a person, such as a wrist computer, finger computer, ring computer, eyeglass computer, belt-clip computer, arm-band computer, shoe computers, clothing computers, and other wearable computers. In various embodiments, for example, a mobile computing device may be implemented as a smart phone capable of executing computer applications, as well as voice communications and/or data communications. Although some embodiments may be described with a mobile computing device implemented as a smart phone by way of example, it may be appreciated that other embodiments may be implemented using other wireless mobile computing devices as well. The embodiments are not limited in this context.

As shown in FIG. 8, device 800 may include a housing 802, a display 804, an input/output (I/O) device 806, and an antenna 808. Device 800 also may include navigation features 812. Display 804 may include any suitable display unit for displaying information appropriate for a mobile computing device. I/O device 806 may include any suitable I/O device for entering information into a mobile computing device. Examples for I/O device 806 may include an alphanumeric keyboard, a numeric keypad, a touch pad, input keys, buttons, switches, rocker switches, microphones, speakers, voice recognition device and software, and so forth. Information also may be entered into device 800 by way of microphone (not shown). Such information may be digitized by a voice recognition device (not shown). The embodiments are not limited in this context.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

While certain features set forth herein have been described with reference to various implementations, this description is not intended to be construed in a limiting sense. Hence, various modifications of the implementations described herein, as well as other implementations, which are apparent to persons skilled in the art to which the present disclosure pertains are deemed to lie within the spirit and scope of the present disclosure.

Realizations in accordance with the present invention have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the various configurations may be implemented as a combined structure or component. These and other variations, modifications, additions, and improvements may fall within the scope of the invention as defined in the claims that follow.

What is claimed is:

1. A device that implements a power saving algorithm comprising:
a video encoder component to receive a detected static image frame, the video encoder component comprising:
a quantizer component configured to decrease quantization parameter (QP) value for the detected static image frame until a desired QP value is obtained, wherein the video encoder component disables hierarchical motion estimation (HME), integer motion estimation (IME), and intra (I) frame encoding components during process of obtaining the desired QP value and until the detected static image frame is turned off;
a zero motion vector (ZMV) component to encode the detected static image frame at non-skip mode, wherein the ZMV component at skip mode is disabled when the desired QP value for the detected static image frame is obtained; and
a bit-packing (PAK) hardware (HW) component to perform bit-rate transmission for the ZMV component.

2. The device of claim 1 wherein the static image frame includes zero motion vectors.

3. The device of claim 1 wherein the detected static image frame includes static image sub-frames that are skipped and non-static image sub-frames that are coded for bit-rate transmission, wherein the non-static image sub-frames include a slice of the static image frame.

4. The device of claim 1 wherein the disabling of the ZMV component includes the disabling of the PAK HW component until the detected static image frame is turned off, wherein the turning off includes detection of another image frame for encoding by the video encoder component.

5. The device of claim 1 wherein the ZMV component starts encoding at skip mode after the desired QP value is obtained.

6. The device of claim 1 wherein the PAK HW component is disabled after the desired QP value is obtained and the ZMV component is at skip mode.

7. The device of claim 1 wherein the PAK HW component performs bit-rate transmission in a single passing.

8. A video encoder comprising:
a quantizer component configured to replenish quality of a received static image frame by dynamically adjusting quantization parameter (QP) value for the received static image frame until a desired QP value is obtained;
a zero motion vector (ZMV) component configured to encode the received static image frame, wherein the ZMV component at skip mode is disabled when the desired QP value is obtained; and
a bit-packing (PAK) hardware (HW) component to perform bit-rate transmission for the ZMV component.

9. The video encoder of claim 8 wherein the received static image frame includes zero motion vectors.

10. The video encoder of claim 8 wherein the received static image frame includes static image sub-frames that are skipped and non-static image sub-frames that are coded for bit-rate transmission, wherein the non-static image sub-frames represent a slice level change on the received static image frame.

11. The video encoder of claim 8 wherein the disabling of the ZMV component includes the disabling of the PAK HW component until the detected static image frame is turned off, wherein the turning off includes detection of another image frame for encoding.

12. The video encoder of claim 8 wherein the ZMV component starts encoding at skip mode after the desired QP value is obtained.

13. The video encoder of claim 8 wherein the PAK HW component is disabled after the desired QP value is obtained and the ZMV component operates at skip mode.

14. The video encoder of claim 8 further comprising hierarchical motion estimation (HME), integer motion estimation (IME), and intra (I) frame encoding components that are disabled by the video encoder during process of obtaining the desired QP value and until the detected static image frame is turned off.

15. A method of implementing a power saving algorithm in video encoding comprising:
detecting a static image frame;
replenishing quality of the detected static image frame until a desired quantization parameter (QP) value is obtained;
disabling decision mode components to include hierarchical motion estimation (HME), integer motion estimation (IME), and intra (I) frame encoding components; and
skipping the detected static image frame by a zero motion vector (ZMV) component that encodes the detected static image frame, wherein the skipping is performed when the desired QP value is obtained.

16. The method of claim 15 wherein the detected static image frame is captured by a display capture component, wherein the static image frame includes zero motion vectors.

17. The method of claim 15 wherein the detected static image frame includes static image sub-frames that are skipped and non-static image sub-frames that are coded for bit-rate transmission, wherein the non-static image sub-frames include a slice of the static image frame.

18. The method of claim 15 wherein the replenishing quality includes decreasing initial QP value for the static image frame until the QP value is obtained.

19. The method of claim 15 wherein the disabling decision mode components does not include the ZMV component and a bit-packing (PAK) hardware component during the process of obtaining the desired QP value.

20. The method of claim 15 wherein the skipping the detected static image frame includes disabling of the ZMV component and a bit-packing (PAK) hardware component until the detected static image frame is turned off, wherein the turning off includes detection of another image frame for encoding by a video encoder component.
